(19) United States
(12) Patent Application Publication
(10) Pub. No.: US 2022/0285831 A1
(43) Pub. Date: Sep. 8, 2022

(54) Roof Module for Forming a Vehicle Roof Comprising an Antenna Module

(71) Applicant: Webasto SE, Stockdorf (DE)

(72) Inventors: Michael HUELSEN, Stockdorf (DE); Oliver HEISEL, Stockdorf (DE); Andreas STRASSER, Stockdorf (DE); Thomas LINDNER, Stockdorf (DE); Max HUBER, Stockdorf (DE)

(21) Appl. No.: 17/632,645

(22) PCT Filed: Aug. 14, 2020
(86) PCT No.: PCT/EP2020/072876

§ 371 Date: Feb. 3, 2022

(30) Foreign Application Priority Data
Aug. 19, 2019 (DE) 10 2019 122 184.6

(51) Int. Cl. H01Q 1/32; B60R 11/04

(52) U.S. Cl. CPC H01Q 1/3275; B60R 11/04; B60R 2011/004

(57) ABSTRACT

A roof module for forming at least a part of the vehicle roof on a motor vehicle, the roof module having a panel component whose outer surface at least partially forms the roof skin of the vehicle roof, the roof module having at least one environment sensor configured to send and/or receive electromagnetic signals for detecting the vehicle surroundings. The roof module has at least one antenna module configured to receive and/or send radio signals.

The invention relates to a roof module for forming a vehicle roof on a motor vehicle according to the preamble of claim 1.

Generic roof modules are widely used in vehicle manufacturing since these roof modules can be prefabricated as separate functional modules and can be delivered to the assembly line when assembling the vehicle. The roof module can be either a part of a rigid vehicle roof or a part of an openable roof sub-assembly.

Autonomously or semi-autonomously driving motor vehicles are increasingly common in vehicle manufacturing. A plurality of environment sensors detecting the surroundings of the motor vehicle and determining the current traffic situation are required in order to enable the vehicle controller to control the motor vehicle autonomously or semi-autonomously. To this end, the known environment sensors send and/or receive corresponding electromagnetic signals, such as laser beams or radar beams, a corresponding signal evaluation allowing a data model of the vehicle surroundings to be generated. The known environment sensors are installed in an appropriate sensor housing in order to protect the environment sensors from harmful environmental conditions, such as humidity and airflows. This sensor housing is mounted on top of the vehicle roof in order to afford the environment sensor a highest possible monitoring position. Mounting an environment sensor at the highest position of the vehicle roof is disadvantageous in that it may compromise the functionality of sending and/or receiving antennas also mounted on the vehicle roof After all, the environment sensor with its sensor housing constitutes an area of obstruction for the sending and/or receiving antennas also mounted on the vehicle roof. For example, if the vehicle antenna for receiving mobile radio data or receiving radar signals is mounted on the side of the vehicle roof facing the vehicle rear, the emission angle of the vehicle antenna is limited by an environment sensor mounted on the side of the vehicle roof facing the front of the vehicle. So far, the only option of avoiding this obstruction by the environment sensor has been to make the vehicle antenna longer at the top, which is undesirable for design reasons, however.

Hence, the object of the present invention is to propose a new roof module which avoids the disadvantages of the state of the art described above.

This object is attained by a roof module according to the teaching of claim 1.

Advantageous embodiments of the invention are the subject matter of the dependent claims.

In the roof module according to the invention, it is provided for the roof module to comprise an antenna module in addition to the at least one environment sensor, said antenna module being configured to receive and/or send radio signals. Consequently, the roof module has the antenna module as well as the environment sensor with the result that the beam path of the antenna module is no longer disturbed by the environment sensor if antenna modules are suitably disposed relative to the environment sensor. Of course, the roof module can also have other functional elements, such as light elements or the like, in addition to the environment sensor and the antenna module. The antenna module needs to be protected from harmful environmental conditions, such as humidity and airflows, in order to ensure a sufficient weather protection of the antenna module. This can be ensured in a particularly simple manner by disposing the antenna module below the roof skin of the vehicle roof formed by the panel component. In particular, this allows the antenna module to be installed in a dry area which is reliably protected from humidity, pollution and airflows.

The panel component should be made of a material permeable to the radio signals of the antenna module, such as plastic or glass, in order to not undesirably disturb the beam path of the antenna module.

Antennas able to receive and/or send radio signals in different frequency ranges may be required depending on the range of functions of the vehicle in question. The different antenna modules required for this purpose can be jointly integrated in the roof module in a simple manner.

It is advantageous for an antenna module to be disposed between two environment sensors in each case with a view to an ideal exploitation of the installation space available in the roof module.

The antenna modules can be of basically any constructive design. According to a preferred embodiment, an antenna module comprises an electronics board, which has a radio antenna integrated thereon, and a grounding plate, which is mounted at a predefined distance from the radio antenna.

In many vehicles, radio reception toward the vehicle is also intended to be possible for the vehicle passengers, such as the sending of Wi-Fi signals or Bluetooth signals to the mobile devices of vehicle passengers and the receiving thereof. What is referred to as radio modules are commonly used for this purpose, by means of which radio signals from the vehicle interior can be received and sent. If this functionality is wanted for a vehicle, the corresponding data module can also comprise a radio modem.

In the simplest architecture in connection with the use of radio modems, the radio modem and the antenna module each form separate components. It is advantageous for the radio modem to be integrated in the antenna module with a view to high cost-efficiency with the result that one sub-assembly implements the functionality of both the antenna module and the radio modem.

Metallic vehicle body elements, such as support plates or plate frames, which have an appropriate mechanical stability, often serve to attach the roof module to the vehicle. It is advantageous for the antenna module to be disposed on the side of the vehicle body element facing outward in order to not compromise the functionality of the antenna module in sending and receiving radio signals from outside the vehicle. At the same time, it is advantageous for the radio modem to be disposed on the side of the vehicle body element facing inward so that the vehicle body element does not obstruct the emission area of the radio modem into the vehicle interior.

Mounting the environment sensors and the antenna modules on top of the vehicle roof requires high precision regarding both the positioning of the individual environment sensors and the individual antenna modules on the vehicle roof and the position of the environment sensors and the antenna modules relative to each other. It is particularly advantageous if at least one environment sensor and at least one antenna module are mounted on a common support element in order to facilitate said exact positioning of the antenna modules and the environment sensors. As a result, all environment sensors and all antenna modules of the roof module can be pre-installed on the common support element and can subsequently be mounted on the vehicle roof together with the support element, for example. In this case, the support element can have mounts, which are prefabricated with appropriate precision, for fixing the environment sensors and the antenna modules, resulting at least in the necessary positioning.

Basically any number of environment sensors and antenna modules can be mounted on the support element. In a preferred variation, the support element makes it possible for an antenna module to be mounted between two environment sensors.

Certain environment sensors require stray light to be avoided. Hence, it is known for stray light shades to be disposed between the individual environment sensors. If such a stray light shade is to be provided, it can be advantageously integrated in the support element. The antenna module can be attached to the stray light shade itself with the result that it obtains the desired positioning in the two environment sensors.

If the antenna module is a separate component, it can be attached to the support element in a removable manner. Alternatively, the antenna module can also be integrated in the support element. To this end, the antenna module can be affixed to the surface of the support element in a non-removable manner. The antenna module can be produced in a particularly cost-efficient manner if it is printed onto a surface of the support element.

As an alternative to printing the antenna module, it can also be injected into a plastic part of the roof module. To this end, the antenna module is overmolded with the plastic of the injection-molded plastic component. In particular, the antenna module can be injected into the support element. It is also conceivable for the antenna module to be injected into a plastic panel component forming the roof skin of the vehicle.

Sending and/or receiving the radio signals from only one position of the vehicle is often insufficient in order to achieve a radio coverage as complete as possible. In particular, obstructions can lead to large areas of disturbance which inadmissibly compromise the functionality of the antenna module. To avoid this, it is particularly advantageous if the roof module comprises at least one front antenna module and at least one rear antenna module. In this case, the front antenna module can receive and/or send radio signals from the area of the vehicle. The rear antenna module can receive radio signals from the area behind the vehicle and/or send radio signals to the rear.

The antenna module can basically use any type of wireless standard. It is advantageous for the antenna module to be able to receive and/or send radio signals and/or mobile radio signals and/or Wi-Fi signals and/or Bluetooth signals and/or GPS signals and/or car-to-car communication signals (DSRC) and/or car-to-X communication signals (DSRC).

The roof module according to the invention offers particularly large advantages with regard to the car-to-car communication signals and/or with regard to the car-to-X communication signals. The antenna module should preferably be configured in the manner of a DSRC patch antenna in order to be able to utilize them.

Basically any type of environment sensor can also be installed in the roof module according to the invention. The roof module offers particularly large advantages in connection with environment sensors which are configured in the manner of a lidar sensor and/or in the manner of a radar sensor and/or in the manner of a camera sensor and/or in the manner of a multi-camera sensor.

The roof module according to the invention can basically be employed both in passenger cars and in utility vehicles, such as delivery vans or tractor units for heavy goods vehicles. It can be configured as a purely solid roof or can be provided with a roof opening system and thus form a closable roof opening.

Furthermore, the roof module according to the invention preferably forms a structural unit which comprises integrated features enabling autonomous driving or semi-autonomous driving supported by driver assistance systems and which can be placed on top of a vehicle body shell by a vehicle manufacturer.

The invention also relates to a motor vehicle comprising a roof module of the kind described above.

Examples of configurations of the subject matter of the invention are schematically illustrated in the drawing and will be explained in more detail in the following description.

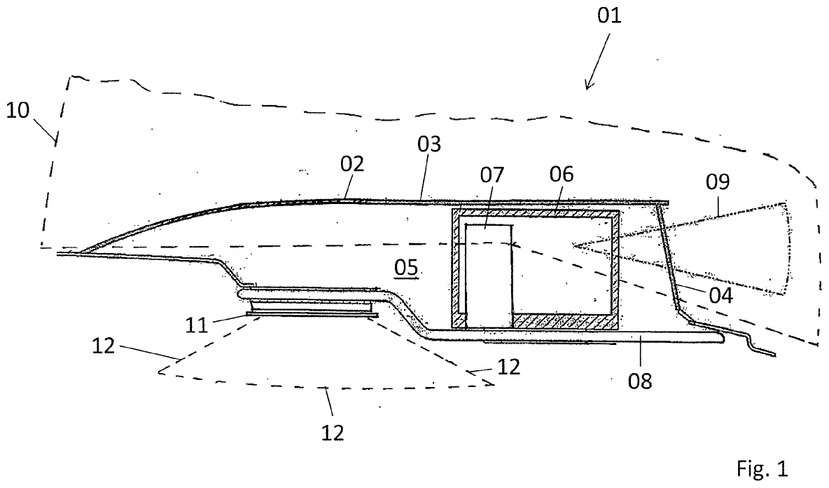

FIG. 1 is a schematic longitudinal section through a first embodiment of a roof module;

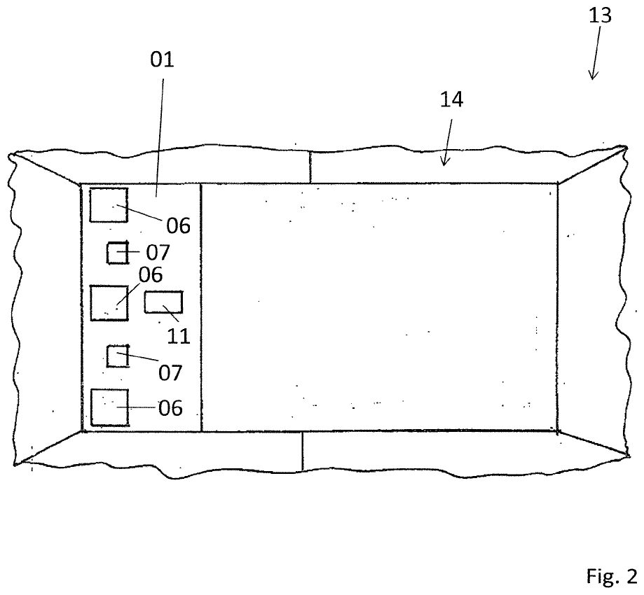

FIG. 2 is a schematic top view of the roof module of FIG. 1 when disposed on a vehicle roof;

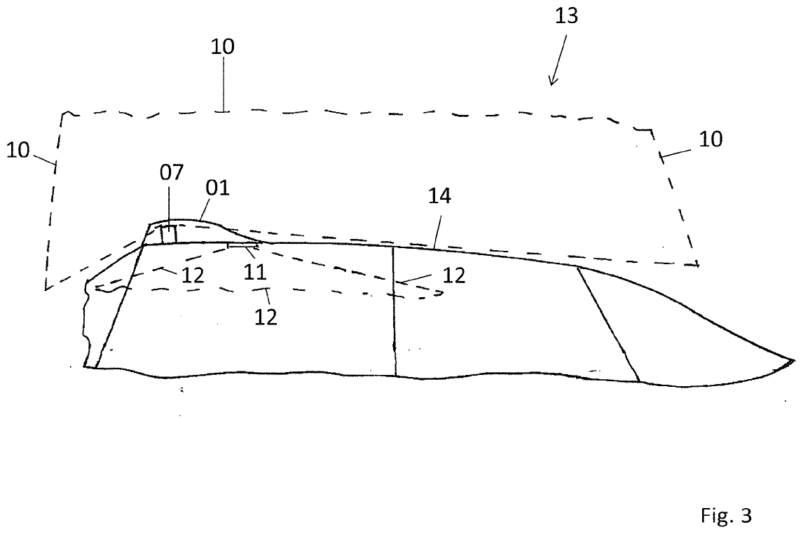

FIG. 3 is a schematic lateral view of the beam path of the antenna module in the roof module of FIG. 1;

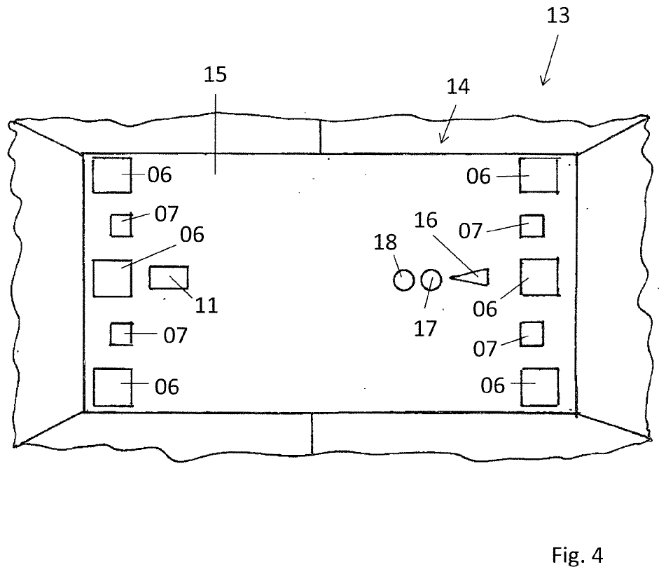

FIG. 4 is a schematic top view of a second embodiment of a roof module when disposed on a vehicle roof;

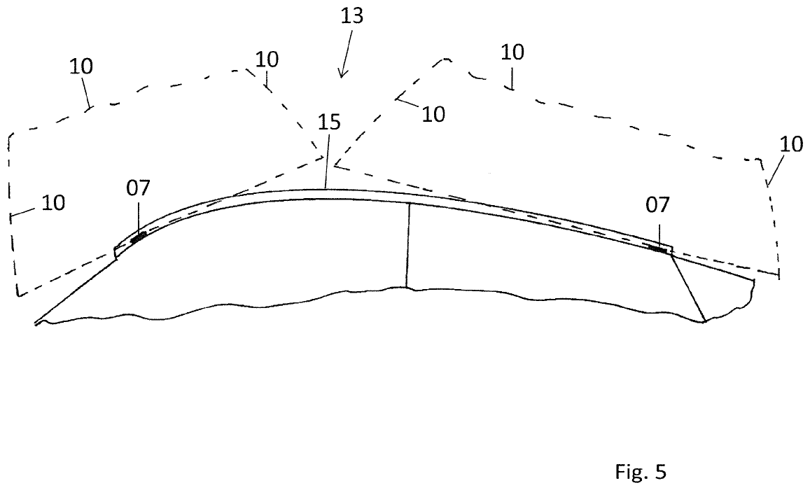

FIG. 5 is a schematic lateral view of the roof module of FIG. 4;

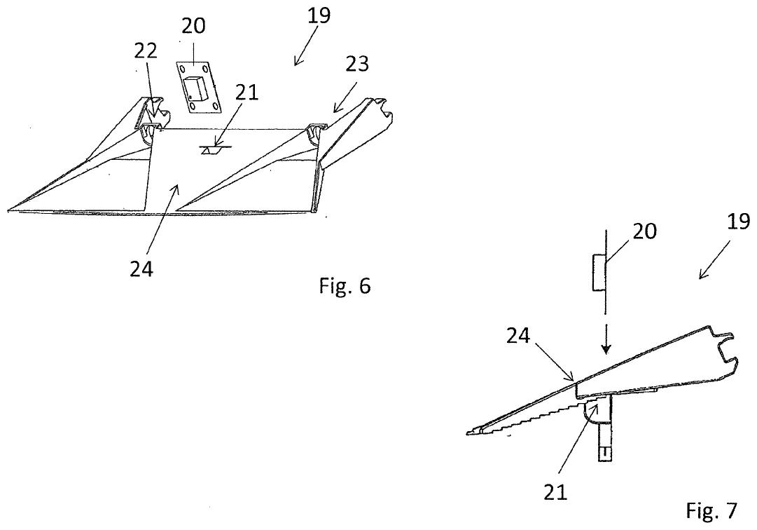

FIG. 6 is a perspective lateral view of a support element for fixing an antenna module in a roof module;

FIG. 7 is a lateral view of the support element of FIG. 6;

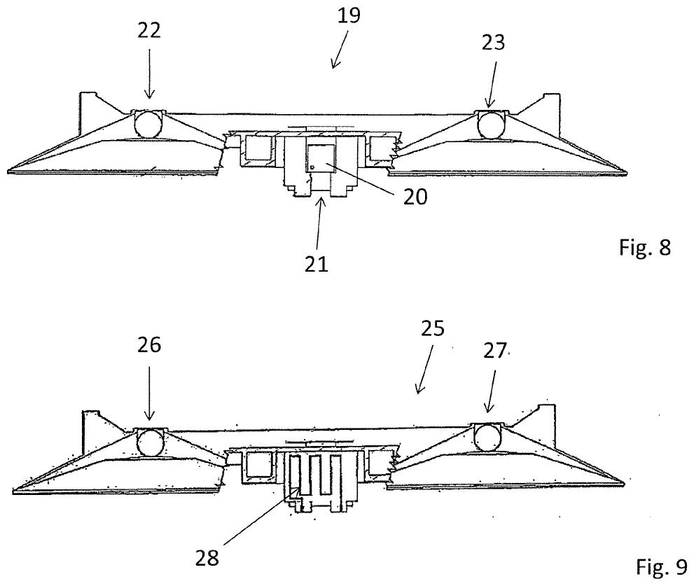

FIG. 8 is a front view of the support element of FIG. 6; and

FIG. 9 is a front view of a second embodiment of a support element.

FIG. 1 shows a first embodiment of a roof module 01 according to the invention. Roof module 01 comprises a panel component 02, which forms roof skin 03 of a vehicle. A cover 04 is provided on the ends of panel component 02 facing the vehicle front. Panel component 02 and cover 04 protect a dry area 05 in roof module 01.

An environment sensor 06, such as a lidar sensor or a radar sensor, and an antenna module 07 are disposed in dry area 05. Both environment sensor 06 and antenna module 07 are mounted on a vehicle body element 08, which limits dry area 05 at the bottom. The beam path of electronic signals 09 emitted by environment sensor 06, which can be laser beams, for example, is indicated by dashes and dots in FIG. 1. The beam path of radio signals 10, which can be received and/or sent by antenna module 07, is also indicated by dashes and dots in FIG. 1. As can be seen, the emission of radio signals 10 is essentially unobstructed by the sensor housing of environment sensor 06 since antenna module 07 and environment sensor 06 are disposed at the same height of the vehicle roof next to each other in roof module 01. Panel component 02 is made of plastic so as to not disturb the passage of radio signals 10 of antenna module 07.

Additionally, roof module 01 has a radio modem 11, which is mounted on the underside of vehicle body element 08. The beam path of radio signals 12, which are emitted and/or received by radio modem 11, is also indicated by dashes and dots in FIG. 1. Radio signals 12 are not disturbed since radio modem 11 is disposed on the side of vehicle body element 08 facing the vehicle interior.

FIG. 2 shows a vehicle 13, on whose vehicle roof 14 roof module 01 is installed on the side facing the vehicle front. FIG. 2 depicts the disposition of environment sensor 06 and antenna module 07 and radio modem 11 in their position relative to each other. In total, roof module 01 comprises three environment sensors 06 and two antenna modules 07, antenna modules 07 each being disposed between two adjacent environment sensors 06.

FIG. 3 shows a schematic lateral view of vehicle 13 in the area of vehicle roof 14. The beam path of radio signals 10 of antenna module 07 is visible. Since roof module 01 is disposed at the highest point of vehicle roof 14, an essentially complete coverage of the radio area can be obtained both to the front and to the rear. Radio signals 12 of radio modem 11 achieve complete radio coverage for the vehicle interior.

FIG. 4 shows a top view of another embodiment of a roof module 15 according to the invention. Roof module 15 again comprises three environment sensors 06, two antenna modules 07 and a radio modem 11 on the side facing the vehicle front. Additionally, three other environment sensors 06 and two other antenna modules 07 are provided in roof module 15 on the side facing the vehicle rear. Additionally, roof module 15 forms an antenna module 16 for receiving radio signals, an antenna module 17 for receiving mobile radio signals, and an antenna module 18 for receiving GPS signals. Antenna modules 07 are configured in the manner of DSRC patch antennas and serve in particular for car-to-car communication and car-to-X communication.

FIG. 5 shows a lateral view of roof module 15 with antenna module 07. Radio signals 10 of antenna modules 07 are visible as an indication in the form of dashes and dots. Since antenna modules are disposed both on the side facing the vehicle rear and on the side facing the vehicle front, good radio coverage is possible both to the front and to the rear despite the obstruction by the vehicle roof.

FIG. 6 shows a support element 19 for installing an antenna module 20 in a roof module according to the invention. Antenna module 20 is configured in the manner of a DSRC patch antenna and suitable in particular for car-to-car communication and car-to-X communication. Support element 19 is made of plastic and has a mount 21, into which antenna module 20 can be plugged from above so as to be fixed. Moreover, support element 19 comprises two mounts 22 and 23, to which two environment sensors, which are not illustrated in FIG. 6, can be attached. The area between the two mounts 22 and 23 is configured in the manner of a stray light shade 24. So antenna module 20 is already fixed to stray light shade 24.

FIG. 7 shows support element 19 as antenna module 20 is being plugged into mount 21 from above.

FIG. 8 shows a front view of support element 19 with the two mounts 22 and 23. Stray light shade 24 is illustrated in a partial cut. Thus, antenna module 20 is visible, which is plugged into mount 21 from above.

FIG. 9 shows a second embodiment 25 of a support element for being installed in a roof module. Support element 25 again has two mounts 26 and 27, to each of which an environment sensor, which is not illustrated in FIG. 9, can be attached. An antenna module 28 is printed onto the plastic surface of support element 25 in the area behind the stray light shade, which is illustrated in a partial cut in FIG. 9.

### REFERENCE SIGNS

01 roof module
02 panel component
03 roof skin
04 cover
05 dry area
06 environment sensor
07 antenna module
08 vehicle body element
09 electromagnetic signal (environment sensor)
10 radio signal (antenna module)
11 radio modem
12 radio signal (radio modem)
13 vehicle
14 vehicle roof
15 roof module
16 antenna module
17 antenna module
18 antenna module
19 support element
20 antenna module
21 mount
22 mount
23 mount
24 stray light shade
25 support element
26 mount
27 mount
28 printed antenna module

1. A roof module for forming at least a part of the vehicle roof on a motor vehicle, the roof module comprising:
a panel component whose outer surface at least partially forms the roof skin of the vehicle roof,
the roof module comprising at least one environment sensor configured to send and/or receive electromagnetic signals for detecting the vehicle surroundings,
wherein the roof module comprises at least one antenna module configured to receive and/or send radio signals.

2. The roof module according to claim 1, wherein the antenna module is disposed below the roof skin formed by the panel component.

3. The roof module according to claim 2, wherein the panel component is made of a material which is permeable to the radio signals of the antenna module.

4. The roof module according to claim 1, wherein the roof module comprises multiple antenna modules, the individual antenna modules each being configured to receive and/or send radio signals in different frequency ranges.

5. The roof module according to claim 1, wherein the antenna module is disposed between two environment sensors.

6. The roof module according to claim 1, wherein the antenna module comprises an electronics board, which has a radio antenna integrated thereon, and a grounding plate, which is mounted at a predefined distance from the radio antenna.

7. The roof module according to claim 1, wherein the roof module comprises a radio modem configured to receive and/or send radio signals from the vehicle interior.

8. The roof module according to claim 7, wherein the radio modem is integrated in the antenna module.

9. The roof module according to claim 1, wherein the roof module comprises at least one metallic vehicle body element, the antenna module being disposed on the side of the vehicle body element facing outward and/or the radio modem being disposed on the side of the vehicle body element facing inward.

10. The roof module according to claim 1, wherein at least one environment sensor and the antenna module are mounted on a common support element.

11. The roof module according to claim 10, wherein two environment sensors are mounted on the support element, the antenna module being mounted between the two environment sensors.

12. The roof module according to claim 10, wherein the support element comprises a stray light shade between the two environment sensors.

13. The roof module according to claim 12, wherein the antenna module is mounted in the area of the stray light shade.

14. The roof module according to claim 10, wherein the antenna module is mounted on the support element in a removable manner.

15. The roof module according to claim 10, wherein the antenna module is affixed to a surface of the support element in a non-removable manner.

16. The roof module according to claim 15, wherein the antenna module is printed onto a surface of the support element.

17. The roof module according to claim 1, wherein the roof module comprises at least one injection-molded plastic component, the antenna module being injected into the plastic of the injection-molded plastic component.

18. The roof module according to claim 1, wherein the roof module comprises at least one front antenna module and at least one rear antenna module, the front antenna module being configured to receive and/or send radio signals from the area in front of the vehicle, and the rear antenna module being configured to receive and/or send radio signals from the area behind the vehicle.

19. The roof module according to claim 1, wherein the antenna module is configured to receive and/or send radio signals and/or mobile radio signals and/or Wi-Fi signals and/or Blue-tooth signals and/or GPS signals and/or car-to-car communication signals (DSRC) and/or car-to-X communication signals (DSRC).

20. The roof module according to claim 19, wherein the antenna module is configured in the manner of a DSRC patch antenna.

21. The roof module according to claim 1, wherein the environment sensor is configured in the manner of a lidar sensor and/or in the manner of a radar sensor and/or in the manner of a camera sensor and/or in the manner of a multi-camera sensor.

22. A motor vehicle comprising a roof module according to claim 1.
